(19) United States
(12) Patent Application Publication
(10) Pub. No.: US 2015/0113291 A1
(43) Pub. Date: Apr. 23, 2015

(54) CYPTOGRAPHIC BRANDING OF DATA CONTAINERS

(71) Applicant: Spectra Logic Corporation, Boulder, CO (US)

(72) Inventors: John Suykerbuyk, Loveland, CO (US); Kenneth David Merry, Lafayette, CO (US)

(73) Assignee: Spectra Logic Corporation, Boulder, CO (US)

(21) Appl. No.: 14/061,065

(22) Filed: Oct. 23, 2013

(51) Int. Cl. H04L 9/30; H04L 9/32

(52) U.S. Cl. CPC H04L 9/30; H04L 9/3236
USPC 713/193

(57) ABSTRACT

Embodiments described are generally directed to ensuring a data storage device originated from a first location. The data storage device including a unique identifier visibly attached to said data storage device and the unique identifier digitally retained by the data storage device. At a first location a first hash of said unique identifier is generated via a hash function. Also at the first location a public key and a private key are created. The first hash is cryptographically signed using the private key. Before sending the data storage device to a second location the cryptographically signed hash is stored to the data storage device along with the public key. At the second location, a second hash of said unique identifier is generated using the same hash function used at the first location. The second hash is compared with a recovered version of the cryptographically signed hash which is decrypted by pairing the cryptographically signed hash with said public key. If the second hash is the same as the recovered first hash the data storage device is validated as originating from the first location.

### CROSS-REFERENCE TO RELATED APPLICATIONS

None

### BACKGROUND OF THE INVENTION

1. Field of the Invention

The present invention relates generally to verifying a physical object originated from a legitimate location without contacting the location. More particularly, some embodiments of the present invention relates to verifying a physical data storage memory device came from a legitimate manufacturer.

2. Description of Related Art

Sending and receiving devices for use in an existing system is big business wherein someone buys a physical device and receives that physical device by way of a shipping service. Unfortunately, sometimes the physical device that is received is a counterfeit. Thankfully, there are mechanisms that help address this problem, such as verifying that the physical device is legitimate based on registering the physical device with a serial number, or tracking the object from origination the shipping location. These verification mechanisms work reasonably well, but require closing the loop with the manufacturer or shipping location. This is not too big a deal with a small shipment of physical devices, but becomes more cumbersome with large shipments of physical devices. Accordingly, this problem is addressed with seals that are difficult to impossible to forge, such as holograms on a sticker. However, these seals can be carefully removed and replaced counterfeit physical objects or optionally similar stickers can be created and placed on the devices. Nonetheless, there is no reasonably good way to verify that a physical device originated from a legitimate location without contacting that location.

It is to innovations related to verifying a physical device originated from a legitimate location that the present invention is generally directed.

### SUMMARY OF THE INVENTION

The present embodiments generally relate to verifying a device that originates from a legitimate location without contacting the location. More particularly, some embodiments of the present invention relate to verifying a physical data storage memory device that came from a legitimate manufacturer or original equipment manufacturer.

Some embodiments of the present invention contemplate a method comprising steps: providing a data storage device possessing non-transitory digital storage medium, housing, unique indicia visibly attached on said housing; a) creating a public key and a private key wherein both of said keys originating at a first location; b) generating a cryptographic hash in digital form of said unique indicia with said private key corresponding to said data storage device; c) storing said cryptographic hash to said non-transitory digital storage media; d) moving said data storage device to a second location; e) verifying that said storage container originated at the first location by validating through said public key that both said cryptographic hash and said indicia originated from said first location, said steps are performed in order from a) to e).

Other embodiments contemplate a data storage device comprising: a mass storage medium; a housing that contains said mass storage medium; a unique identifier visibly disposed on said housing; a digital representation of said unique identifier retained by said mass storage medium; a public key; a cryptographic hash of said digital representation of said unique identifier wherein said data storage device is verifiable as having originated from a first location when located in a second location only after said cryptographic hash is decrypted via said public key and compared with a hash of said unique identifier.

Yet some embodiments of the present invention contemplate a method for ensuring a physical box originated from a first location, the method comprising: providing a unique identifier visibly attached to said physical box; creating a public key and a private key at said first location wherein said public and said private keys are paired in a unique relationship; generating a first hash of said unique identifier via a hash function; encrypting said first hash by pairing with said private key to form a cryptographically signed hash; including said cryptographically signed hash with said physical box; transferring said public key to a second location; transferring said physical box to said second location; at said second location, generating a second hash of said unique identifier via said hash function; at said second location, decrypting said cryptographically signed hash by pairing with said public key to recover said first hash; comparing said second hash with said recovered first hash; validating that said physical box originated from said first location if said second hash and said recovered first hash are the same.

### BRIEF DESCRIPTION OF THE DRAWINGS

FIG. 1 is an illustration of a tape cartridge originating from a first location and verified at a second location in accordance with certain embodiments of the present invention.

FIG. 2 is a block diagram of a method of steps to make secure the physical box at a first location in accordance with an embodiment of the present invention.

FIG. 3 is a block diagram of a method of steps verifying that the physical box from FIG. 2, now located in a second location, originated from the first location constructed in accordance with certain embodiments of the present invention.

FIG. 4 depicts a commercial embodiment of the present invention of a disk drive being transferred securely from a first location to a second location in accordance with an embodiment of the present invention.

### DETAILED DESCRIPTION

Initially, it is to be appreciated that this disclosure is by way of example only, not by limitation. The data transfer concepts herein are not limited to use or application with any specific system or method for using storage element devices. Thus, although the instrumentalities described herein are for the convenience of explanation, shown and described with respect to exemplary embodiments, it will be appreciated that the principles herein may be applied equally in other types of storage element systems and methods involving the storage and retrieval of data.

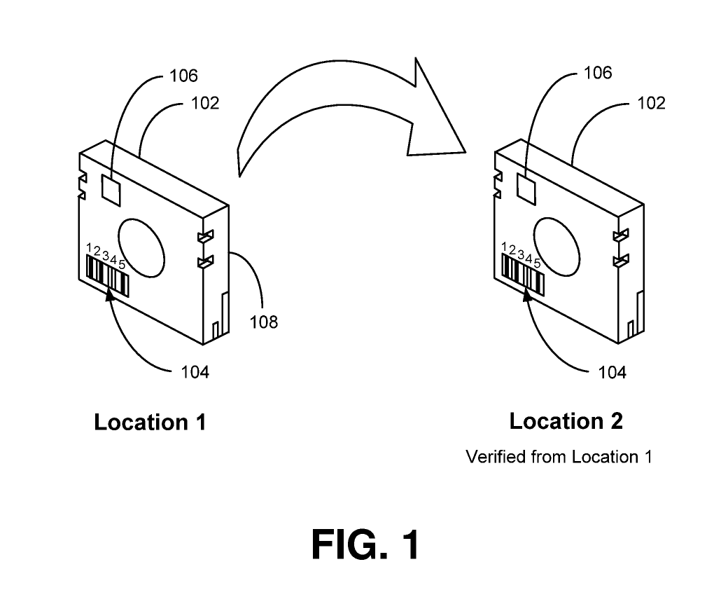

To illustrate an exemplary environment in which preferred embodiments of the present invention can be advantageously practiced, FIG. 1 shows a tape cartridge 102 that possesses a non-transitory magnetic tape memory or medium (not shown) that is contained within the tape housing 108. Disposed visibly seen on the tape housing 108 is a unique bar code 104 with a unique number “12345”. The tape cartridge 102 further possesses a non-transitory memory device 106 that can retain a cryptographic hash of the unique bar code 104. As illustratively shown, the tape cartridge 102 is moved from a first location to a second location. By comparing a hash of the bar code with the decrypted cryptographic hash of the bar code retained by non-transitory memory device 106, the tape cartridge can be verified with confidence that the tape cartridge originated from location 1. This process combats the problem where location 2 receives a counterfeit tape cartridge originating at an unknown location. Though the difference between a first location and a second location is considered to be as far as countries apart, it is conceivable that they are as close as two buildings or different rooms in a building, for example.

For purposes of this description and meaning of the claims, the term “memory” or “medium” means a tangible data storage device, including non-volatile memories (such as flash memory and the like) and volatile memories (such as dynamic random access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

Though preferred embodiments are directed to storage devices, such as the tape cartridge 102 of FIG. 1, or optionally a disk drive, a solid state drive, a mobile flash drive, etc., other embodiments contemplate a non-storage physical box, such as a cardboard box comprising a unique indicia that is viewable to an onlooker, such as a label or bar code. At the first location, the unique indicia is turned into a hash via a hash function and then encrypted to create a cryptographic hash with a numerical key or preferably a private key mathematically related to the numerical key. The cryptographic hash can be stored on the box, such as by non-transitory flash memory, a non-transitory RFID chip (Radio Frequency Identification device), or potentially just an analogue representation, such as another label, or a stamp, or hand written with a marker, for example. At a second location, the cryptographic hash is decrypted with the numerical key, the unique indicia is turned into a hash yet again via a hash function and compared against the decrypted hash. If they are the same, then there is confidence at the second location that the physical box came from the first location. Otherwise, the box may be a counterfeit from an unknown location.

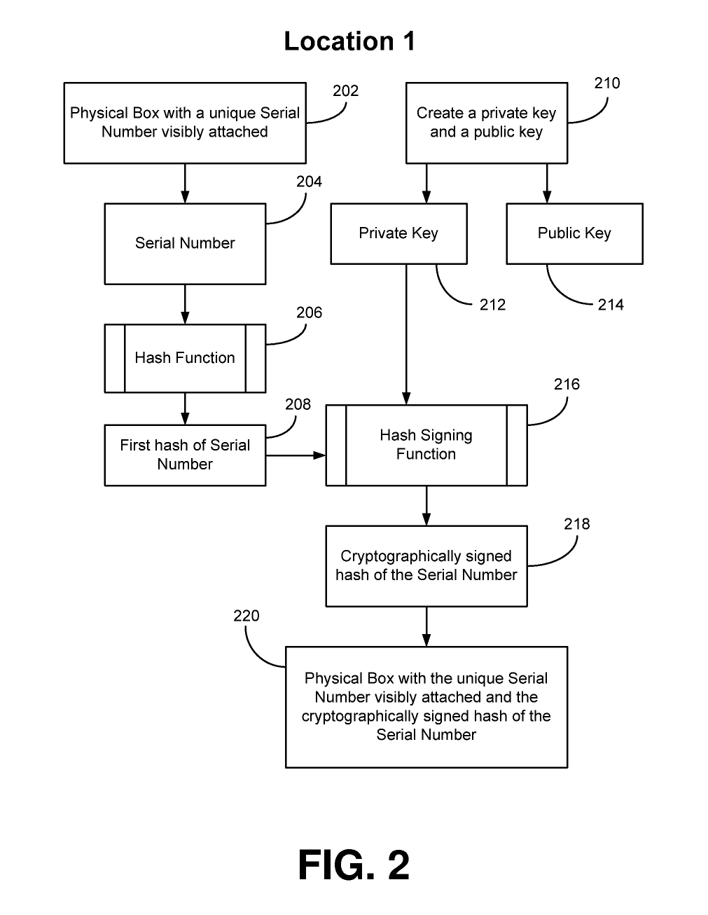

FIG. 2 shows method steps to make secure the physical box at a first location. A physical box is provided with unique indicia, such as a serial number, visibly attached to an outer surface of the box, step 202. Embodiments of unique indicia include serial number/s, bar code/s, patterned stamp/s, or other indicia that is unique. Embodiments of a physical box include physical, tangible items such as a shipping container, electronic device with a housing, etc. Originating at the first location, shown in step 210, a private key 212 and public key 214 are created. Although, the private and public keys are different, the private and public key pair are mathematically linked. One example of a secure key is an RSA key, which uses exponentiation modulo, a product of two very large numbers (RSA stands for Rivest, Shamir and Adleman who were the creators of this secure technique). Key algorithms are based on mathematical problems, which currently admit no efficient solution that are inherent in certain integer factorization, discrete logarithm, and elliptic curve relationships. It is computationally easy for a user to generate his or her public and private key-pair and to use them for encryption and decryption. The strength lies in the fact that it is “impossible” (computationally infeasible) for a properly generated private key to be determined from its corresponding public key. Thus, the public key may be published without compromising security, whereas the private key must not be revealed to anyone not authorized to read messages or perform digital signatures. Optional embodiments contemplate just one key and not a private and public key. As shown in step 204, unique indicia information (such as a serial number shown here) is obtained from the physical box. As shown in step 206, once obtained, the unique indicia information is passed through a hash function, which is a mathematical function that computes a kind of “digital fingerprint” of the unique indicia information (this can be a program kernel embedded in a larger program or a chip with an embedded algorithm, for example). The hash function takes an arbitrary block of data (the unique indicia or serial number) and returns a fixed-size bit string, such as a 256 bit RSA hash value. Any (accidental or intentional) change to the unique indicia information will (with very high probability) change the hash value. Hence, with the hash function, the unique indicia information (e.g., serial number) is generated into a first hash value, step 208. As shown in step 216, the private key 212 and the first hash value 208 are jointly used by an encryption algorithm create a cryptographically signed hash of the first hash value 218 (a digital signature of the first hash value). In step 220, the cryptographically signed hash of the serial number 218 is provided with the physical box.

The cryptographically signed hash of the serial number 218 is contemplated being provided with physical box in one or more of a variety of ways. For example, one embodiment contemplates the cryptographically signed hash of the serial number 218 retained in an RFID chip. Other embodiments contemplate the cryptographically signed hash of the serial number 218 retained in a non-transitory flash memory device included with the physical box. Another embodiment contemplates the physical box as a storage device, such as a magnetic disk drive, wherein the cryptographically signed hash of the serial number 218 can be retained on the magnetic disk contained therein. Another embodiment contemplates the physical box is a tape cartridge 102 and the cryptographically signed hash of the serial number 218 is retained on the magnetic tape contained therein, or optionally on a medium auxiliary memory (MAM) chip located inside of the tape cartridge 102. Another embodiment contemplates the physical box is a Solid State Drive (SSD) and the cryptographically signed hash of the serial number 218 is retained on the Solid State memory comprised by the SSD. Another embodiment contemplates the cryptographically signed hash of the serial number 218 is a string of numbers that is visibly written or disposed on the physical box.

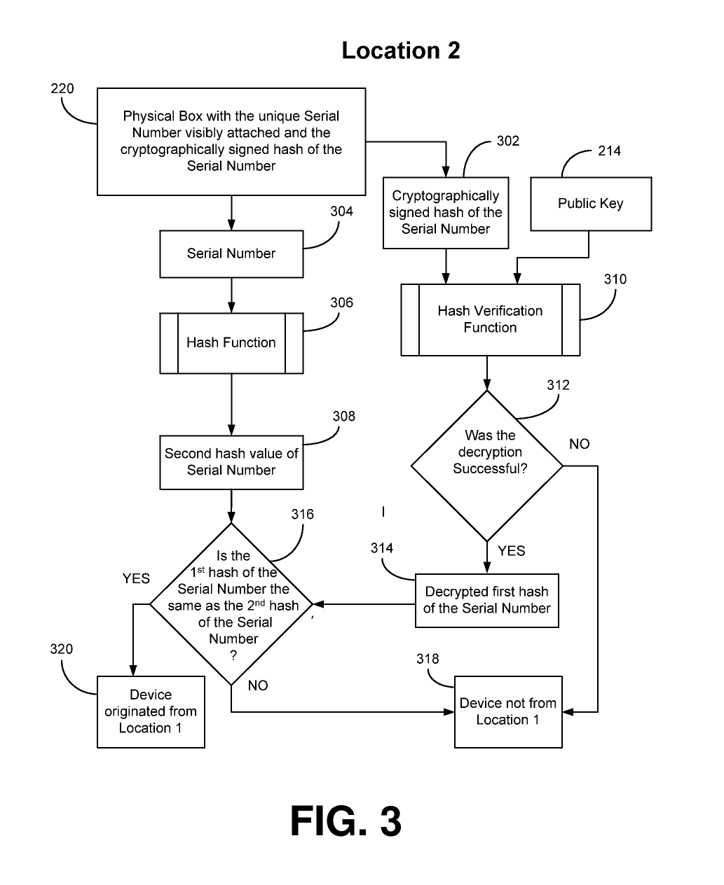

With reference to FIG. 3, a method of verifying that the physical box from FIG. 2, now located in a second location, originated from the first location is presented. As shown in step 220, the physical box includes a) the unique indicia (e.g., serial number) visibly attached to the outer surface of the box in addition to b) possessing cryptographically signed hash of the serial number. As shown in step 304, the unique indicium (e.g., the serial number) is obtained from the physical box. Next, as shown in step 306, once obtained the unique indicia information is passed through the same hash function 206 of the first location, which returns a second fixed-size bit string hash value (such as a 256 bit RSA hash value), step 308. The second fixed-size bit string hash value 308 should be the same as the fixed-size bit string hash value 208 from the first location.

With continued reference to FIG. 3, as shown in step 302, the cryptographically signed hash of the serial number is obtained from the physical box. As previously discussed, if the cryptographically signed hash of the serial number is retained in an RFID, an RFID reader will read the cryptographically signed hash of the serial number. If the cryptographically signed hash of the serial number is retained in storage on different storage device, then the cryptographically signed hash of the serial number can be retrieved from the different storage device. If the cryptographically signed hash of the serial number is visibly disposed on the physical box or in the box (such as a slip of paper, for example), the cryptographically signed hash of the serial number is obtained directly. As shown in step 310, the public key 214, which is now accessible in location 2, is used to decrypt (verify) the cryptographically signed hash of the serial number obtained from step 302 via the hash verification function 310 (such as by an RSA hash verification function/decryption engine). The public key 214 can be sent to the second location by way of a second pathway, such as physically sent or electronically via the internet, phone, or some other manner known in the art. Some embodiments contemplate the public key being sent with the physical box. If the decryption is successful, step 312, the result is a decrypted hash value of the serial number, which is believed to be the first hash value of step 208, step 312. If the decryption is not successful, then the physical box did not come from the first location, step 318. Decision step 316 compares the second hash value obtained in step 308 with first hash value obtained in step 314. If the first hash value 314 is the same as the second hash value 308 then the box is verified as coming from the first location, step 320. If the first hash value 314 is not the same as the second hash value 308 then the physical box did not come from the first location, step 320.

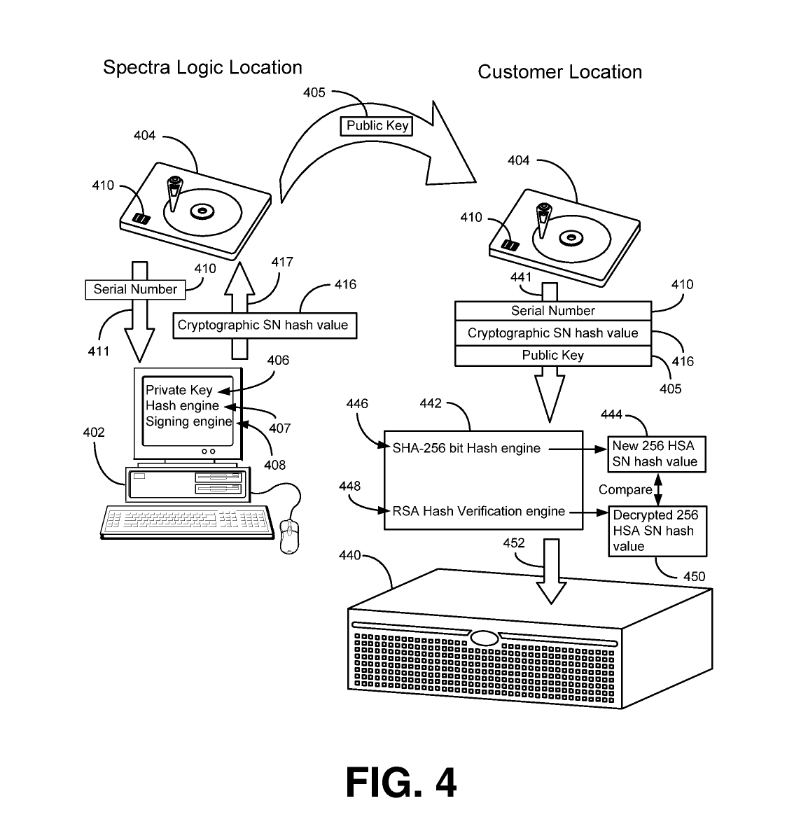

As depicted in FIG. 4, a commercial environment in which embodiments of the present invention can be practiced includes a Spectra Logic nTier Verde storage device 440, which is an archive grade disk drive array (a mass storage JBOD, Just a Bunch Of Drives, device possessing forty four disk drives per JBOD) produced by Spectra Logic Corporation of Boulder, Colo. Consistent with embodiments of the present invention, Spectra Logic Corporation may desire to have any disk drive that becomes incorporated into an nTier Verde storage device 440 at a customer location come from Spectra Logic Corporation and not from someone else. In other words, all disk drives in an nTier Verde storage device 440 originate from Spectra Logic Corporation—Spectra Logic disk drives talk to Spectra Logic disk drives. Reasons for wanting to verify that disk drives going into an nTier Verde storage device 440 originate from Spectra Logic Corporation may be to ensure that the disk drives have been specially screened, are warrantied from failure based on Spectra Logic Corporation's standards of operation, may contain special of proprietary system operations software, are to avoid compatibility conflicts between different disk drives and different generations of the same disk drives, etc.

At the Spectra Logic location, an RSA public key and a private key are created by OpenSSL, which is an open source Secure Sockets Layer of cryptographic protocols designed for internet communications security developed at Netscape Communications of Mountain View Calif. OpenSSL is a program that can run on a computer system, such as computer system 402. OpenSSL supports a number of different cryptographic algorithms such as ciphers (AES, Blowfish, Camellia, SEED, CAST-128, DES, IDEA, RC2, RC4, RC5, Triple DES, GOST 28147-89), cryptographic hash functions (MD5, MD2, SHA-1, SHA-2, RIPEMD-160, MDC-2, GOST R 34.11-94), and public-key cryptography (RSA, DSA, Diffie-Hellman key exchange, Elliptic curve). It should be noted that these functions historically are used for securing and authenticating code or digital messages, but in no way are used in conjunction with securing a physical object. Once the public key and private key are created, the public key can be provided to anyone who needs it, but the private key is maintained at Spectra Logic where it is password protected.

When a customer requests a plurality of disk drives from Spectra Logic, an embodiment of a validation routine consistent with FIGS. 2 and 3 can be initiated. Each disk drive possesses a unique serial number viewable on the outside of the disk drive. A first serial number 410 from a first disk drive 404 is scanned into a computer system 402 at Spectra Logic (that is, a digital representation of the serial number 410) shown by arrow 411. This can be accomplished with a bar code scanner or read directly from the first disk drive 404 (assuming the serial number is digitally maintained by the first disk drive 404) when electrically connected to the computer system 402. The computer system 402 can include a user interface (keyboard and mouse in this example), screen, computing processors (macroprocessors and microprocessors), non-transitory memory (flash memory, solid state memory, disk drives, etc.), operating system, software, etc. Once the computer system 402 is in possession of the first serial number 410, a first SHA-256 bit hash function (256 bit number) is generated from the first serial number 410 via an SHA-256 bit hash engine 407 provided by OpenSSL operating by the computer system 402. The term engine is used herein to be synonymous with a software program running on a processor or algorithm on an integrated circuit chip, wherein the engine transforms the first serial number 410 into a hash function. Generally speaking, all SHA-256 bit hash functions, whether from OpenSSL or another algorithm/software source (such as LIBTOMCRYPT, from Ottawa, Canada), are compatible. Meaning, the same SHA-256 hash will be generated from the first serial number 410 regardless of the source, so long as it is an SHA-256 hash engine (routine) 407. Together with the private key 406, the first SHA-256 bit hash function is cryptographically signed (encrypted) by an RSA hash cryptographic signing function/routine 408, such as by LIBTOMCRYPT or OpenSSL, for example. The cryptographically signed first SHA-256 bit hash function 416 is then stored to the first disk drive 404 as indicated by the arrow 417. This is then repeated using the same private key 406 with all of the disk drives that are intended to be shipped to the customer's nTier Verde storage device 440 at the customer location. The public key 405 is also shipped to the customer location. One embodiment contemplates that public key 405 is stored to the first disk drive 404. Another embodiment contemplates that the public key 405 is stored to each of the disk drives.

Once at the customer location, the first disk drive 404 (and the rest of the disk drives) is electronically linked to a computing system 442 that can read both the first serial number 410 and the cryptographically signed first SHA-256 bit hash function 410, see arrow 441. The computing system 442 is shown here as a box, but could be like the computing system 402, or be part of the nTier Verde storage device 440, or other computing system consistent with features of a computing system 402 described above. Once in possession by the computing system 442, a second SHA-256 bit hash function 444 (256 bit number) is generated from the first serial number 410 via an SHA-256 bit hash function engine 446 (program/algorithm) running on the computer system 442. The computer system 442 also having possession of the cryptographically signed first SHA-256 bit hash function of the first serial 416 number decrypts the signed hash 416 with the public key 405 via an RSA hash verification engine 448 (program/algorithm) running on the computer system 442. If the cryptographically signed first SHA-256 bit hash function of the first serial number is successfully decrypted, then the decrypted first SHA-256 bit hash function 450 is compared with the second SHA-256 bit hash function 444. If the two numbers 444 and 450 are the same, then the first disk drive 404 originated from Spectra Logic and is free to operate in the nTier Verde storage device 440, see arrow 452. If the two numbers 444 and 450 are not the same or if the cryptographically signed first SHA-256 bit hash function 416 of the first serial number 410 does not decrypt, then the first disk drive 410 did not originate from Spectra Logic and is not free to operate in the nTier Verde storage device 440. One embodiment contemplates installing the disk drives in the nTier Verde storage device 440 wherein an error will post and the disk drives will be inoperable if the disk drives are determined not to be from Spectra Logic using the above sequence of steps.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, different kinds of physical devices or even a physical box could use the disclosed functionality while still maintaining substantially the same functionality without departing from the scope and spirit of the claimed invention. Another example can include using these techniques can be used for other devices possessing memory that are replacement components for a greater system or original components in a greater system (greater system example being the Spectra Logic nTier Verde storage system) while still maintaining substantially the same functionality without departing from the scope and spirit of the claimed invention. Finally, although the preferred embodiments described herein are directed to disk drive device, and related technology, it will be appreciated by those skilled in the art that the claimed invention can be applied to other systems, without departing from the spirit and scope of the present invention.

It will be clear that the claimed invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the claimed invention disclosed and as defined in the appended claims. Accordingly, it is to be understood that even though numerous characteristics and advantages of various aspects have been set forth in the foregoing description, together with details of the structure and function, this disclosure is illustrative only, and changes may be made in detail, especially in matters of structure and arrangement to the full extent indicated by the broad general meaning of the terms in which the appended claims are expressed.

What is claimed is:

1. A method comprising steps:
providing a data storage device possessing non-transitory digital storage medium, housing, unique indicia visibly attached on said housing;
a) creating a public key and a private key wherein both of said keys originating at a first location;
b) generating a cryptographic hash in digital form of said unique indicia with said private key corresponding to said data storage device;
c) storing said cryptographic hash to said non-transitory digital storage media;
d) moving said data storage device to a second location;
e) verifying that said storage container originated at the first location by validating through said public key that both said cryptographic hash and said indicia originated from said first location, said steps are performed in order from a) to e).

2. The method of claim 1 wherein said data storage device is from a group consisting of a tape cartridge, a disk drive, or a solid state drive.

3. The method of claim 1 wherein said digital storage media is from a group consisting of magnetic tape media, solid state memory, magnetic disk, optical disk, or optical magnetic disk.

4. The method of claim 1 wherein unique indicia is from a group comprising a bar code, serial number, and device model number.

5. The method of claim 1 wherein said private key is only at said first location.

6. The method of claim 5 wherein said cryptographic hash cannot be created or recreated without said private key.

7. The method of claim 1 wherein said public key and said private key do not correspond to data capable of being retained on said digital storage media.

8. A data storage device comprising:
a mass storage medium;
a housing that contains said mass storage medium;
a unique identifier visibly disposed on said housing;
a digital representation of said unique identifier retained by said mass storage medium;
a public key;
a cryptographic hash of said digital representation of said unique identifier wherein said data storage device is verifiable as having originated from a first location when located in a second location only after said cryptographic hash is decrypted via said public key and compared with a hash of said unique identifier.

9. The data storage device of claim 8 wherein said mass storage medium is selected from a group consisting of solid state memory, magnetic disk memory, or magnetic tape.

10. The data storage device of claim 8 wherein said public key is generated at the same time a private key is generated, the private key is retained in said first location and is never located in said second location.

11. A method for ensuring a physical box originated from a first location, the method comprising:
providing a unique identifier visibly attached to said physical box;
a) creating a public key and a private key at said first location wherein said public and said private keys are paired in a unique relationship;
b) generating a first hash of said unique identifier via a hash function;
c) signing said first hash by pairing with said private key to form a cryptographically signed hash;
d) including said cryptographically signed hash with said physical box;
e) transferring said public key to a second location;
f) transferring said physical box to said second location;
g) at said second location, generating a second hash of said unique identifier via said hash function;
h) at said second location, verifying said cryptographically signed hash by pairing with said public key to recover said first hash;
i) comparing said second hash with said recovered first hash;
j) validating that said physical box originated from said first location if said second hash and said recovered first hash are the same.

12. The method of claim 11 disposing said cryptographically signed hash visibly on said physical box.

13. The method of claim 11 storing said cryptographically signed hash in a storage device possessed by said physical box wherein before said decrypting step retrieving said cryptographically signed hash from said storage device.

14. The method of claim 13 wherein said storage device is a flash memory device included with said physical box.

15. The method of claim 13 wherein said storage device is a mass storage medium essentially contained in said physical box.

16. The method of claim 15 wherein said physical box is a disk drive, a solid state memory device, or a tape cartridge.

17. The method of claim 11 wherein said physical box contains more than one disk drive, solid state memory device, or tape cartridge.

18. The method of claim 11 wherein said signing step is accomplished through an RSA hash signing function device and said verifying step is accomplished through an RSA hash verification function device.

19. The method of claim 11 wherein said physical box does not include digitally stored user data.

20. The method of claim 11 wherein said steps b), c), d), e), h), I, and j) are performed in that order.

21. The method of claim 11 wherein said physical box is a disk drive and said cryptographically signed hash, said unique identifier, and said public key are all retained in said disk drive; steps g)-j) are performed by a data storage system when said disk drive is electronically linked thereto.

22. The method of claim 21 wherein said data storage system rejecting said disk drive if determined that said second hash and said recovered first hash are not the same.
